(19) United States
(12) Patent Application Publication
(10) Pub. No.: US 2004/0203355 A1
(43) Pub. Date: Oct. 14, 2004

(54) System and method for enabling a mobile phone

(76) Inventors: Jeffrey Ross Light, Lincolnwood, IL (US); George Jay Hruska, Naperville, IL (US); Stephen C. Goss, Wheaton, IL (US)

Correspondence Address: FAY, SHARPE, FAGAN,, MINNICH & McKEE, LLP, Seventh Floor, 1100 Superior Avenue, Cleveland, OH, 44114-2518, US

(21) Appl. No.: 10/189,673

(22) Filed: Jul. 3, 2002

(51) Int. Cl. H04B 5/00

(52) U.S. Cl. 455/41.1; 455/411

(57) ABSTRACT

A system for enabling a mobile phone for wireless communications operation is provided. The system includes identification means for providing enabling identification information to the mobile phone in a wireless manner. The system also includes a mobile phone having a sensor for sensing the enabling identification information, and a transmitter for transmitting registration information to a wireless communications network thereby enabling the phone for wireless communications operation. A method for enabling a mobile phone for wireless communications operation on a wireless communications network is also provided. The method includes bringing identification means within the proximity of a mobile phone initially in standby mode to transfer enabling identification information to the phone in a wireless manner. The mobile phone registers with the network using the enabling information which enables the mobile phone for wireless communications operation.

### BACKGROUND OF THE INVENTION

The present invention relates to a system and method of enabling a mobile phone, and more particularly to a system and method of transferring enabling identification information to any one of a plurality of mobile phones so that a subscriber can enable the phone for wireless communications operation.

In order for a person to communicate by mobile phone over a wireless communications network the network must have information identifying the phone and the subscriber who owns the phone. For example, in a cellular communications system, mobile phones typically use a registration process in which the phone and subscriber are identified to the network with a combination of a mobile identity number (MIN) and an electronic serial number. The network can use this information to direct incoming calls to the phone as well as identify the phone's owner, that is, the person who subscribed with the network provider to use the phone on the wireless communications network. Proper identification of the subscriber is useful for billing purposes and to provide the services to which the subscriber is entitled.

In order to provide unique identification, this information is typically tied to a particular phone. However, this inflexible approach can reduce the subscriber's ability to communicate by limiting them to using only the features and capabilities provided by that particular phone. For example, if the mobile phone is a low powered phone, the subscriber may have difficulty in using it to communicate in mountainous terrain as compared to phones having higher power. As another example, many mobile phones are not well suited for use in an automotive environment.

It is desirable to enable a subscriber to use any one of a variety of mobile phones while maintaining a single mobile subscription identity.

### SUMMARY OF THE INVENTION

According to the present invention, a system for enabling a mobile phone for wireless communications operation is provided. The system includes identification means for providing enabling identification information to the mobile phone in a wireless manner. The enabling identification information can include subscriber identification information. The system also includes a mobile phone having a sensor for sensing the enabling identification information, and a transmitter for transmitting registration information, including the enabling identification information, to the wireless communications network thereby enabling the phone for wireless communications operation.

In accordance with one aspect of the present invention, a wireless identification module for providing enabling identification information to a mobile phone is provided. The wireless identification module includes a transmitter for transmitting the enabling identification information in a wireless manner to enable the phone for wireless communications operation by an authorized user.

In accordance with another aspect of the invention, a method for enabling a mobile phone for wireless communications operation on a wireless communications network is provided. The phone is initially operating in an unregistered standby mode. The method includes bringing identification means capable of providing enabling identification information within the proximity of the mobile phone. The enabling information can identify a subscriber. The method also includes transferring the enabling identification information from the identification means to the mobile phone in a wireless manner. The method also includes registering the mobile phone with the network using registration information derived from the enabling information and information identifying the particular phone to enable the mobile phone for wireless communications operation.

The advantages and benefits of the present invention will become apparent to those of ordinary skill in the art upon reading and understanding the following detailed description of the preferred embodiments.

### BRIEF DESCRIPTION OF THE DRAWINGS

The drawings are only for purposes of illustrating preferred embodiments and are not to be construed as limiting the invention. The invention may take form in various components and arrangements of components, and in various steps and arrangements of steps, preferred embodiments of which will be illustrated in the accompanying drawings wherein:

FIG. 1 is block diagram of system for enabling a mobile phone in accordance with the invention; and

FIG. 2 illustrates a method of enabling a mobile phone in accordance with the invention.

### DETAILED DESCRIPTION OF THE INVENTION

It is to be understood that the specific devices and processes illustrated in the attached drawings, and described in the following specification are simply exemplary embodiments of the inventive concepts defined in the appended claims. Hence, specific examples and characteristics relating to the embodiments disclosed herein are not to be considered as limiting, unless the claims expressly state otherwise.

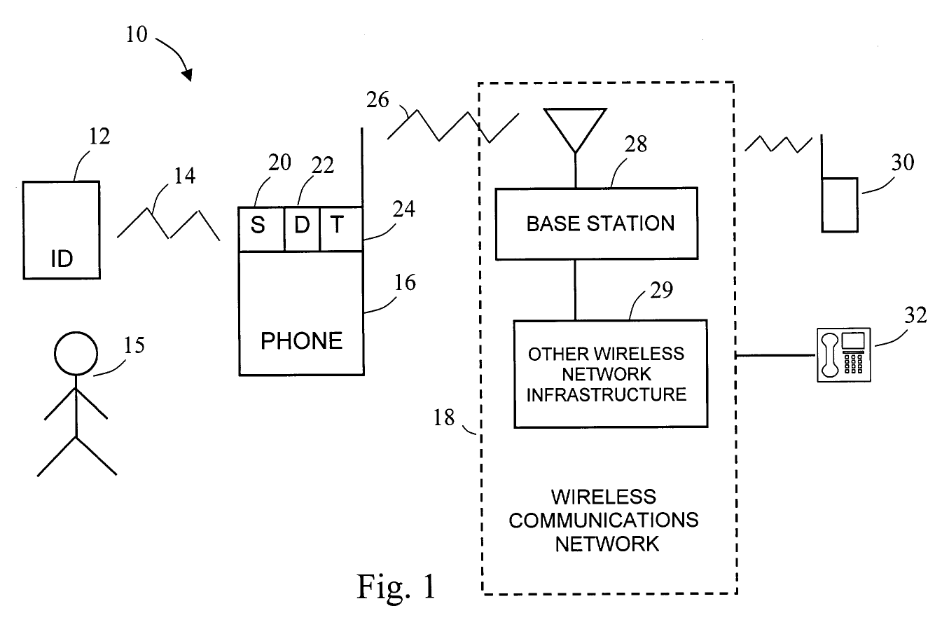

Referring to FIG. 1, a system for enabling a mobile phone for wireless communications operation on a wireless communications network is shown generally at 10. The system includes identification means 12, also referred to a wireless identification module, for wirelessly transferring information over a wireless path as shown at 14. The identification means 12 transfers the information to a mobile phone 16. The transferred information is enabling information which is used to enable the mobile phone 16 for wireless communications operation on a wireless communications network shown generally at 18. The enabling information identifies a subscriber 15 who has subscribed with a wireless communications provider (not shown) to communicate using the wireless communications network 18.

The identification means 12 can be any suitable device or system for wirelessly transferring the enabling identification information to the phone 16 using any known short-distance wireless format. Examples of the identification means 12, which should not be considered as limiting, can include any suitable known transponder such as an active or passive transponder. The identification means can also be a conventional fob.

Other examples of identification means 12 can include any suitable known low power radio transmitting devices. These devices can use Bluetooth, 802.11, or any other suitable known wireless radio transmission format for transferring the enabling identification information to the phone 16.

The mobile phone 16, also known as a mobile phone or cellular phone, can be a car phone, a hands-free car phone, a stationary wireless phone, a ruggedized phone, a high powered phone, a satellite phone or any other suitable known mobile phone for providing wireless communications over any suitable wireless communications network 18. The wireless communications network 18 can be GSM, CDMA, TDMA, analog, radio terminal technology, satellite, or any other conventional wireless communications network.

The phone 16 also includes a sensor S, shown at 20, for sensing the enabling identification information transferred by the identification means 12. Any suitable known sensor 20 adapted to receive the enabling identification information from the identification means 12 can be used. For example, for a passive transponder 12, an active sensor 20 capable of reading, and thus receiving the information from the transponder in a wireless manner is used. For identification means 12 using a low power radio transmitter, the sensor 20 includes a radio receiver using a known transmission/reception format suitable for receiving the identification information.

The mobile phone 16 can also include a decoder D shown at 22 for decoding the enabling identification information received by the sensor 20. The decoder 22 decodes the information in any suitable known manner into a form which can be used by the phone for transmission to the network as described below. The decoder 22 may be included as part of the sensor assembly, or as a separate component. The decoder 22 can be optional in which case the sensor 20 provides the identification information in a usable form to the phone 16.

The phone 16 also includes a transmitter T shown at 24. The phone 16 transmits registration information derived from the enabling identification information and information which identifies the mobile phone 16 to the wireless communications network 18 over a conventional wireless path shown at 26, typically used for registering conventional wireless mobile phones. The phone 16 can transmit the registration information to any suitable component in the wireless communications network 18, such as a base station 28 or other wireless network infrastructure 29. The registration information is processed by the network 18, as described below, to enable the phone 16. The enabled phone 16 can then be used for wireless communications operation by a user, such as the subscriber 15, to communicate with other mobile phones 30 or wired phones 32 using the wireless communications network 18. Wired phones 32 can include, but are not limited to, telephones connected to the Public Switched Telephone Network PSTN, or phones connected for Voice Over Internet Protocol operation.

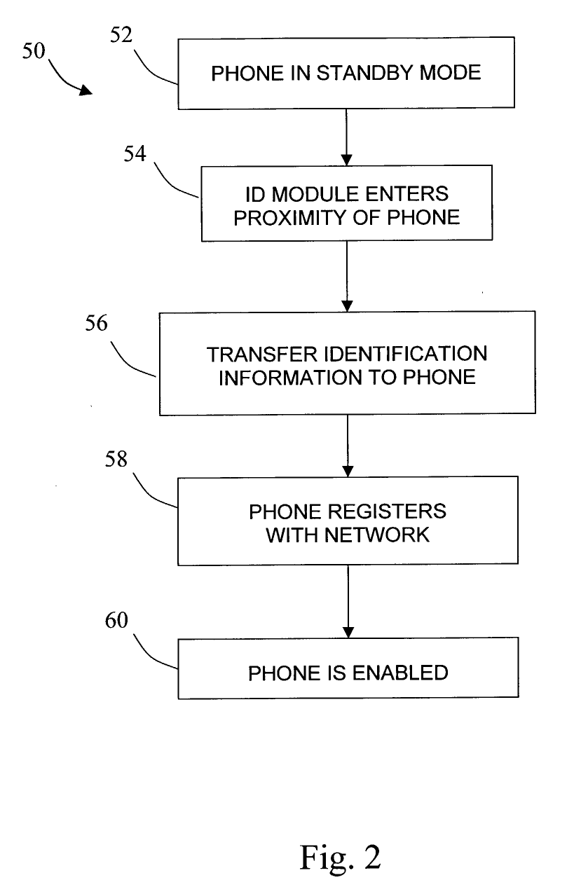

Referring now to FIG. 2, a method for enabling a mobile phone 16 for wireless communications operation on a wireless communications network 18 is shown generally at 50. Initially, the phone 16 is in standby mode as shown at 52. In standby mode, the network 18 does not associate the phone 16 with the subscriber 15 the phone is not enabled for wireless communications operation. With the phone 16 in standby mode, a user 15 cannot originate, that is send, or receive calls.

The method includes bringing the identification module 12 within the proximity of the mobile phone 16 at 54. Such proximity can be defined as a distance between the module 12 and sensor 20 which is sufficiently short enough to transfer the enabling identification information. Examples of these distances can include hundreds of feet or less, or tens of feet or less, or a foot or less, although any suitably short distances may be used.

The method also includes transferring the enabling identification information from the identification module 12 to the mobile phone 16 in a wireless manner at 56. The enabling identification information can be transferred in any suitable manner using any suitable known apparatus for wirelessly transferring information short distances. Any suitable known method of authentication may be used including RFID tags, encrypted codes, etc. to provide a secure transmission if so desired.

The method further includes registering the mobile phone 16 with the network 18 at 58 to enable the mobile phone for wireless communications operation. During the registration step 58 registration information derived from the enabling identification information, which identifies the subscriber, and information identifying the particular phone are used.

The registration information is transmitted by the transmitter 24 from the phone 16 to the wireless network 18 and processed in a known manner. In the registration step 58, the network 18 associates the subscriber 15 with the particular phone 16 used so that calls to the subscriber can be directed to the phone. Also, the association of the information by the network 18 allows the wireless communications service provider to provide the subscriber 15 with the proper services and benefits they have subscribed to.

The registration step 58 can include any suitable known process of registration applicable to the wireless technology used by the wireless communications network 18, including any suitable known handshaking, authentication and validation procedures. After the mobile phone 16 has registered with the network, the phone is enabled for wireless communications operation at 60.

The invention allows the subscriber to move between home, office, and car thereby taking advantage of the different features and capabilities of separate communication devices at different locations and while maintaining a single mobile identity number. The invention includes a wireless interface between the identification module 12 and the phone 16 so that the subscriber will not have to plug in chips, cards, modules, etc. into the phone 16 in order to effectively enable the phone for operation.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. A wireless identification module having a transmitter for providing enabling identification information to a mobile phone in a wireless manner to enable the phone for wireless communications operation by a user.

2. The wireless identification module defined in claim 1 wherein the transmitter is a transponder.

3. The wireless identification module defined in claim 1 wherein the transmitter is a low power radio transmitter.

4. The wireless identification module defined in claim 1 wherein the transmitter is included in another mobile phone.

5. The wireless identification module defined in claim 1 wherein the enabling identification information is a mobile identity number.

6. The wireless identification module defined in claim 1 wherein the enabling identification information is an electronic serial number.

7. A system for enabling a mobile phone for wireless communications operation on a wireless communications network by a user comprising:
identification means for providing enabling identification information to the mobile phone in a wireless manner; and
a mobile phone comprising:
a sensor for sensing the enabling identification information, and
a transmitter for transmitting registration information derived from the enabling identification information to the wireless communications network thereby enabling the phone for wireless communications operation by a user.

8. The system for enabling a mobile phone defined in claim 7 wherein the identification means is a fob.

9. The system for enabling a mobile phone defined in claim 7 wherein the identification means is a transponder.

10. The system for enabling a mobile phone defined in claim 7 wherein the identification means is a low power radio transmitter.

11. The system for enabling a mobile phone defined in claim 7 wherein the identification means is included in another mobile phone.

12. The system for enabling a mobile phone defined in claim 7 wherein the enabling identification information is a mobile identity number.

13. The system for enabling a mobile phone defined in claim 7 wherein the enabling identification information is an electronic serial number.

14. A method for enabling a mobile phone for wireless communications operation on a wireless communications network by a user comprising:
bringing identification means for providing enabling identification information within the proximity of a mobile phone;
transferring the enabling identification information from the identification means to the mobile phone in a wireless manner; and
registering the mobile phone with the network to enable the mobile phone for wireless communications operation by a user.

15. The method for enabling a mobile phone defined in claim 14 wherein the registering step includes the phone transmitting registration information derived from the enabling identification information to the wireless communications network

16. The method for enabling a mobile phone defined in claim 14 wherein the transferring step includes transferring the enabling identification information from a transponder.

17. The method for enabling a mobile phone defined in claim 14 wherein the transferring step includes transferring the enabling identification information using low power radio signals.

18. The method for enabling a mobile phone defined in claim 14 wherein the transferring step includes transferring the enabling identification information from another mobile phone.

19. The method for enabling a mobile phone defined in claim 14 wherein enabling identification information is a mobile identity number.

20. The method for enabling a mobile phone defined in claim 14 wherein enabling identification information is an electronic serial number.
